(19) United States
(12) Patent Application Publication
(10) Pub. No.: US 2025/0079037 A1
(43) Pub. Date: Mar. 6, 2025

(54) MAGNET WIRE WITH THERMOPLASTIC INSULATION THAT REDUCES COPPER POISONING

(71) Applicant: ESSEX SOLUTIONS USA LLC, Atlanta, GA (US)

(72) Inventors: Zhiyang Zhao, Fort Wayne, IN (US); Shengqing Xu, Fort Wayne, IN (US); Guadalupe A. Arambula, Fort Wayne, IN (US); Matthew E. Leach, Fort Wayne, IN (US)

(21) Appl. No.: 18/821,216

(22) Filed: Aug. 30, 2024

Related U.S. Application Data
(60) Provisional application No. 63/535,548, filed on Aug. 30, 2023.

(51) Int. Cl. H01B 3/36; H01B 1/02; H01B 3/42

(52) U.S. Cl. CPC H01B 3/36; H01B 1/026; H01B 3/427

(57) ABSTRACT

Magnet wire with thermoplastic insulation that reduces copper poisoning may include a conductor, and at least one layer of thermoplastic insulation formed around the conductor. Additionally, the thermoplastic insulation may include a matrix polymeric material and one or more additives incorporated into the matrix polymeric material, wherein the one or more additives mitigate copper poisoning, such as migration of copper ions from the conductor into the insulation layer, decomposition of the insulation layer as a result of copper ions, and/or oxidation on the surface of the conductor.

### CROSS-REFERENCE TO RELATED APPLICATION

This application claims priority to U.S. Provisional Application No. 63/535,548, filed Aug. 30, 2023 and entitled “Magnet Wire Insulation That Reduces Copper Poisoning,” the contents of which is incorporated by reference herein in its entirety.

### TECHNICAL FIELD

Embodiments of the disclosure relate generally to magnet wire and, more particularly, to magnet wire including thermoplastic insulation that reduces or limits copper poisoning.

### BACKGROUND

Magnet wire, also referred to as winding wire or magnetic winding wire, is utilized in a wide variety of electric machines and devices, such as inverter drive motors, motor starter generators, transformers, etc. Typically, magnet wire is constructed by applying electrical insulation to a metallic conductor, such as a copper or alloy conductor. The insulation provides electrical integrity and prevents shorts in the magnet wire. Certain magnet wire includes thermoplastic polymeric insulation that is melt extruded onto a conductor. Thermoplastic insulation may be negatively impacted due to migration of copper ions from the conductor into the insulation. Such copper ion migration may occur, for example, as a result of oxidation of the conductor, acidic hydrolysis, and/or reactions with chemicals in an application environment (e.g., water, CO₂, SO₂, SO₃, other gases, etc.). This copper ion migration or copper poisoning causes decomposition of the insulation material, lower thermal endurance, loss of adhesion, reduced dielectric properties, and/or other negative effects.

Additionally, migration or permeation of oxygen through the thermoplastic insulation to the conductor initiates an oxidation reaction with the copper conductor. The rate of oxygen permeation typically increases with elevated temperatures. The resulting oxidation reaction often leads to the formation of complex copper oxidation and will result in eventual loss of adhesion of the thermoplastic insulation from the conductor. Loss of insulation adhesion may lead to catastrophic failure of the magnet wire. Oxidation also results in increased copper ion formation at the interface between the conductor and the insulation and can increase copper ion migration into the insulation.

For many thermoplastic materials typically used in magnet wire, such as polyetheretherketone (“PEEK”), copper ion migration can greatly reduce the performance of the insulation. As a result, magnet wire including thermoplastic materials formed directly on the conductor may exhibit poor performance and/or poor adhesion over time. Indeed, conventional magnet wires that incorporate thermoplastic insulation often include a base layer of enamel or thermosetting material positioned between the conductor and the thermoplastic layer. If the copper ion migration can be mitigated or reduced, high performance magnet wire may be produced with thermoplastic insulation formed directly on the conductor.

Accordingly, there is an opportunity for improved magnet wire including thermoplastic insulation that mitigates, reduces, or minimizes copper poisoning. In particular, there is an opportunity for improved thermoplastic magnet wire insulation that includes or incorporates one or more additives that mitigate or reduce copper poisoning.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIGS. 1A-1D are cross-sectional views of example magnet wire constructions that include insulation that reduces copper poisoning, according to illustrative embodiments of the disclosure.

FIG. 2 is a schematic illustration of the suppression of copper poisoning as a result of incorporating one or more additives into magnet wire insulation, according to an illustrative embodiment of the disclosure.

### DETAILED DESCRIPTION

Various embodiments of the present disclosure are directed to magnet wire that includes a conductor and extruded thermoplastic insulation formed around the conductor where the thermoplastic insulation includes one or more additives that mitigate, reduce, or limit copper poisoning. Other embodiments of the present disclosure are directed to methods of forming magnet wire. An example method may include providing a conductor and extruding thermoplastic insulation around the conductor. Additionally, one or more additives that mitigate, reduce, or limit copper poisoning may be blended into, mixed into, or otherwise incorporated into a thermoplastic resin material prior to extrusion of the thermoplastic insulation.

According to an aspect of the disclosure, the magnet wire conductor may include copper. For example, the conductor may be formed from copper, oxygen free copper, a copper alloy, another material including copper, or a material that includes a copper layer laminated or coated onto another metal, alloy, or structure.

In certain embodiments, thermoplastic insulation may be formed directly on the conductor. Additionally, in certain embodiments, a single layer of thermoplastic insulation may be formed around the conductor. In other embodiments, a multi-layer insulation system may be formed around the conductor and at least one insulation layer may be formed from thermoplastic insulation. For example, a plurality of thermoplastic insulation layers may be successively extruded, co-extruded, or otherwise formed around the conductor. In various embodiments, the plurality of layers may be formed from the same material (e.g., the same thermoplastic material with one or more additives that mitigate copper poisoning), similar materials (e.g., similar base or matrix thermoplastic materials containing different additives, similar materials in which one layer includes additive(s) and one layer does not), or at least two layers may be formed from different materials. In other embodiments, a multi-layer insulation system may combine one or more extruded thermoplastic layers with one or more additional types of insulation layers, such as one or more enamel layers formed from thermosetting materials, one or more semi-conductive layers, one or more tape wraps, etc. Indeed, a wide variety of different insulation constructions may be utilized.

A wide variety of different types of thermoplastic insulation may be utilized to form an extruded thermoplastic layer around the conductor including, but not limited to, polyester, copolyester, polyamide including nylon and polyphenylamide (“PPA”), polyphenylene sulfide (“PPS”), polyphenylsulfone (“PPSU”), polyethersulfone (“PESU”), crosslinked polyolefins (e.g., crosslinked polyethylene, cyclopolyolefins (“COC”), etc.), polycarbonate, polystyrene, an acrylics polymer, a fluoropolymer, a silicone polymer, polyurethane, polyaryletherketone (“PAEK”) including polyetheretherketone (“PEEK”) and/or other PAEK materials, polyetherketoneketone (“PEKK”), polymers that include at least one ketone group, etc. As desired, a thermoplastic layer may be formed from a single polymeric material or from a blend of two or more materials. In the event that a blend is utilized, any suitable blend ratios may be utilized. In certain embodiments, at least one layer of extruded thermoplastic insulation may include one or more polyaryletherketone materials and/or suitable polymers that include at least one ketone group and/or their copolymers, such as PAEK, PEEK, PEKK, etc.

As desired in various embodiments, a wide variety of different additives and/or combinations of additives may be incorporated into one or more thermoplastic insulation layers to mitigate copper poisoning. For example, one or more additives may be incorporated (e.g., blended into, laminated onto, coated, on, etc.) into a matrix or base thermoplastic insulation layer formed directly around a conductor. As another example, one or more additives may be incorporated into one or more thermoplastic insulation layers formed around at least one underlying layer with the underlying layer(s) formed around the conductor. The additives may include, but are not limited to, additives that function as acid scavengers (e.g., strong bases, weak bases, metal oxides, etc.), antioxidants, additives that function as thermal stabilizers, cross-linking additives, and/or any suitable combinations of additives. In certain embodiments, a single additive may be utilized. In other embodiments, a combination of additives or a blend of multiple additives may be utilized. In the event that a combination of additives is incorporated, any suitable blending ratio of additives may be utilized.

In certain embodiments, one or more additives may include at least one suitable strong base material as an acid scavenger, such as lithium hydroxide, magnesium hydroxide, calcium hydroxide, barium hydroxide, and/or hydrates of these materials. In other embodiments, one or more additives may include at least one suitable weak base material as an acid scavenger, such as aluminum hydroxide, zirconium (IV) hydroxide, zirconium (IV) carbonate hydroxide oxide, aluminum dihydrogen phosphate, sodium hydrogen phosphate, lead hydroxide acetate, ammonium bicarbonate, calcium phosphosilicate, and/or molecular sieves. In yet other embodiments, one or more additives may include at least one suitable metal oxide material as a weak base material that functions as an acid scavenger, such as vanadium (V) oxide, barium oxide, magnesium oxide, calcium oxide, zirconia, and/or titania. In other embodiments, one or more additives may include at least one thermal stabilizer, such as one or more antioxidants including, but not limited to, triaryl phosphate, aromatic phosphite, secondary aromatic amine, and/or a free radical scavenger. In yet other embodiments, one or more additives may include one or more thermal stabilizers, such as iron oxalate, ferrocene, and/or a derivative of ferrocene. In yet other embodiments, one or more additives may include at least one suitable chemical crosslinker, including but not limited to, polyamideimide, aromatic bismaleimide, aromatic benzoxazine, epoxy novolac resin, epoxy resin of phenol-dicyclopentadiene adducts, aromatic amine, and/or carbodilite. In yet other embodiments, any suitable combination of additives may be utilized, such as any of the additives discussed above.

Additionally, any suitable loading factors of additives within the matrix or base thermoplastic polymeric resin may be utilized as desired. In other words, any suitable weight percentage of additives may be incorporated into an insulation layer. In certain embodiments, any additive (or a combination of additives) may constitute between approximately 0.1 percent (0.1%) and approximately thirty percent (30%) by weight of an insulation layer. For example, the additives may constitute between approximately 0.3 percent (0.3%) and approximately twenty-five percent (25%) by weight of an insulation layer. As another example, the additives may constitute between 0.5 percent (0.5%) and ten percent (10%) by weight of an insulation layer. In various embodiments, the additives may constitute approximately 0.1, 0.3, 0.5, 1.0, 1.5, 2.0, 2.5, 3.0, 4.0, 5.0, 6.0, 7.0, 8.0, 9.0, 10.0, 12.0, 15.0 18.0, 20.0, 22.0, 25.0, 28.0, or 30.0 percent by weight of an insulation layer, a weight percentage included in a range between any two of the above values, or a weight percentage included in a range bounded on the maximum end by one of the above values. Further, different additives and/or additive types may be incorporated into insulation layers at differing weight percentages in order to achieve desired mitigation of copper poisoning.

For purposes of this disclosure, the term “copper poisoning” shall mean at least one of (i) copper ion migration from a copper conductor into a surrounding insulation layer, (ii) polymer decomposition within an insulation layer as a result of copper ion migration into the insulation layer, and/or (iii) copper ion formation or oxidation on the surface of a copper conductor and/or at an interface of a copper conductor and a surrounding insulation layer, wherein the copper ion formation may result in reduced adhesion of the insulation layer and/or increased copper ion migration into the insulation layer. For purposes of this disclosure, the term “mitigate” as it pertains to an insulation layer that mitigates copper poisoning shall mean to reduce or lessen copper poisoning relative to matrix or base insulation that does not incorporate one or more additives. As a result of incorporating one or more additives into magnet wire insulation to mitigate copper poisoning, decomposition of the insulation may be reduced, limited, or suppressed. Further, delamination and/or loss of adhesion of the thermoplastic insulation may be reduced or limited. Oxidation of the copper conductor may also be reduced or limited. In certain embodiments, the long-term electrical performance of the magnet wire may be improved. For example, the thermal endurance of the magnet wire may be improved, especially at elevated temperatures in the presence of air and moisture, and/or in the presence of auto transmission fluid or other fluids used in a motor. Further, in certain embodiments, magnet wire including thermoplastic insulation formed directly around a conductor may have enhanced electrical performance, such as enhanced partial discharge inception voltage (“PDIV”) and/or enhanced dielectric strength or dielectric breakdown voltage.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

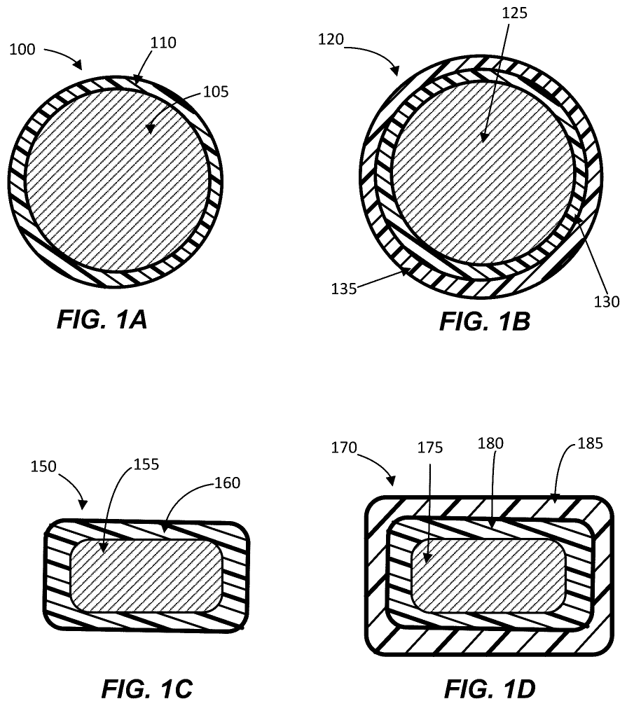

FIGS. 1A-1D illustrate cross-sectional views of example magnet wires constructions that include thermoplastic insulation that reduces or mitigates copper poisoning. In particular, FIG. 1A illustrates a cross-sectional view of an example magnet wire having a round or circular cross-sectional shape in which a single layer of insulation 110 is formed around a conductor 105. FIG. 1B illustrates another example magnet wire 120 having a round cross-sectional shape. The magnet wire 120 may include a conductor 125 and multiple layers 130, 135 of insulation formed around the conductor 125. In other words, the magnet wire 120 may include a basecoat insulation layer 130 formed around the conductor 125, and at least one additional layer of insulation (e.g., topcoat layer 135) formed around the basecoat 130. Although a single additional layer of insulation 135 is illustrated in FIG. 1B, any suitable number of insulation layers may be formed around a basecoat layer 130. For example, a magnet wire 120 may include a basecoat insulation layer, a midcoat insulation layer, and a topcoat insulation layer. In other embodiments, more than three insulation layers may be formed around a magnet wire.

FIG. 1C illustrates an example magnet wire 150 having a rectangular cross-sectional shape in which a single layer of thermoplastic insulation 160 is formed around a conductor 155. FIG. 1D illustrates another example magnet wire 170 having a rectangular cross-sectional shape. Similar to the magnet wire 120 of FIG. 1B, the magnet wire 170 of FIG. 1D may include a conductor 175 and first and second layers 180, 185 of insulation formed around the conductor 175. In other words, the magnet wire 170 may include a basecoat insulation layer 180 formed around the conductor 175, and at least one additional layer of insulation (e.g., topcoat layer 185) formed around the basecoat 180. Any number of additional layers of insulation may be utilized as desired. For example, the magnet wire 170 may include two, three, or any other suitable number of total insulation layers.

The insulation of the example magnet wire constructions 100, 120, 150, 170 illustrated in FIGS. 1A-1D may be formed from a wide variety of suitable materials and/or combinations of materials. For example, insulation layers may be formed from thermoplastic polymeric materials, thermoset polymeric materials, and/or other suitable materials (e.g., semi-conductive materials, inorganic materials including ceramics, glass, etc.), suitable wraps or tapes, etc. Indeed, as described in greater detail below, magnet wire may be formed with a wide variety of suitable insulation systems. According to an aspect of the disclosure, at least one of the thermoplastic insulation layers formed around a magnet wire conductor incorporates one or more additives that function to reduce copper poisoning. Additionally, in certain embodiments, a thermoplastic insulation layer incorporating one or more additives may be formed directly on the conductor.

Each of the layers or components of the magnet wire 170 of FIG. 1D will now be described in greater detail. The example magnet wires 100, 120, 150 of FIGS. 1A-1C may include layers or components similar to those described with reference to FIG. 1D. Indeed, as desired in various embodiments, a magnet wire may be formed with a wide variety of suitable cross-sectional shapes and insulation configurations provided that at least one layer of insulation includes one or more additives that function to reduce copper poisoning.

With reference to FIG. 1D, the conductor 175 may be formed from a wide variety of suitable materials and/or combinations of materials. For example, the conductor 175 may be formed from copper, annealed copper, oxygen-free copper, silver-plated copper, nickel plated copper, tin plated copper, lead plated copper, molybdenum plated copper, tungsten plated copper, copper clad aluminum (“CCA”), a conductive alloy, a material that is coated with copper, or any other suitable electrically conductive material that includes copper. Additionally, the conductor 175 may be formed with any suitable dimensions and/or cross-sectional shapes. As shown, the conductor 175 may have a rectangular cross-sectional shape. In other embodiments, such as those illustrated in FIGS. 1A and 1C, a conductor may have a circular or round cross-sectional shape. In yet other embodiments, a conductor may be formed with a square shape, an elliptical or oval shape, a hexagonal shape, or any other suitable cross-sectional shape. Additionally, as desired for certain cross-sectional shapes such as the illustrated rectangular shape, a conductor may have corners that are rounded, sharp, smoothed, curved, angled, truncated, or otherwise formed. For example, a shaped rectangular wire may have rounded corners.

The conductor 175 may also be formed with any suitable dimensions, such as any suitable gauge, diameter, height, width, cross-sectional area, etc. As one non-limiting example, the longer sides of a rectangular conductor 175 may be between approximately 0.020 inches (508 μm) and approximately 0.750 inches (19050 μm), and the shorter sides may be between approximately 0.020 inches (508 μm) and approximately 0.400 inches (10160 μm). An example square conductor may have sides between approximately 0.020 inches (508 μm) and approximately 0.500 inches (12700 μm). An example round conductor may have a diameter between approximately 0.010 inches (254 μm) and approximately 0.500 inches (12700 μm). Other suitable dimensions may be utilized as desired.

A wide variety of suitable methods and/or techniques may be utilized to form, produce, or otherwise provide a conductor 175. In certain embodiments, a conductor 175 may be formed by drawing input material (e.g., a larger conductor, rod stock, etc.) through one or more dies in order to reduce the size of the input material to desired dimensions. As desired, one or more flatteners and/or rollers may be used to modify the cross-sectional shape of the input material before and/or after drawing the input material through any of the dies. In certain embodiments, the conductor 175 may be formed in tandem with the application of a portion or all of the insulation system. In other words, conductor formation and application of insulation material may be conducted in tandem. In other embodiments, a conductor 175 with desired dimensions may be preformed or obtained from an external source, and insulation material may then be applied via a subsequent process.

With continued reference to FIG. 1D, a plurality of insulation layers 180, 185 are depicted as being formed around the conductor 175. In other embodiments, as shown in FIGS. 1A and 1C, a single insulation layer (e.g., a single layer of extruded thermoplastic insulation) may be formed around the conductor. In the event that a plurality of insulation layers 180, 185 are formed around the conductor, any suitable number of insulation layers may be formed. For example, as shown in FIG. 1D, a first basecoat insulation layer 180 and a second topcoat insulation layer 185 may be formed. As another example, three insulation layers may be formed, such as a basecoat, a midcoat, and a topcoat layer. Other embodiments may include more than three layers.

Additionally, each insulation layer 180, 185 may be formed from a wide variety of suitable materials. For example, one or more insulation layers may be formed from extruded thermoplastic materials, such as a single thermoplastic layer, a plurality of successively extruded thermoplastic layers, or a plurality of co-extruded thermoplastic layers. As another example, one or more insulation layers formed as enamel layers from thermosetting polymeric materials may be combined with at least one extruded thermoplastic insulation layer. In certain embodiments in which the magnet wire 170 includes a plurality of insulation layers 180, 185, each of the layers may be formed from the same polymeric material. For example, a plurality of extruded layers may be formed from the same thermoplastic resin. In other embodiments, at least two of the insulation layers (e.g., layers 180, 185, etc.) may be formed from different materials, materials having different molecular constructions and/or compositions, and/or materials having different additives and/or additive ratios. For example, two thermoplastic layers may be formed from different materials and/or different material blends. As another example, a first insulation layer may be formed from a thermoset polymeric material and a second insulation layer may be formed from a thermoplastic material.

A wide variety of suitable fillers and/or additives may be selectively incorporated into any of the insulation layers. Additionally, according to an aspect of the disclosure, one or more additives that mitigate copper poisoning may be incorporated into at least one thermoplastic insulation layer and, as desired, into any number of insulation layers. For example, additives may be incorporated into each of the layers or into a subset of the layers, such as one or more layers (i.e., a basecoat, etc.) formed closest to the conductor 175. Examples of suitable additives are discussed in greater detail below.

According to an aspect of the disclosure, a magnet wire 170 may be formed with an insulation system that includes one or more layers of thermoplastic polymeric insulation, such as one or more extruded layers of polymeric insulation. A thermoplastic insulation layer is typically formed by melt extruding a thermoplastic polymeric material around a conductor 175 (and, if present, any underlying insulation layers). Any number of thermoplastic insulation layers may be formed in various embodiments. Additionally, each layer of thermoplastic polymeric insulation may have any desired thickness, such as a thickness between approximately 15 micrometers (15 μm) and approximately 600 micrometers (600 μm), a thickness between approximately 15 micrometers (15 μm) and approximately 400 micrometers (400 μm), or a thickness between approximately 15 micrometers (15 μm) and 600 micrometers (600 μm). In various embodiments, a thermoplastic insulation layer may have a thickness of approximately 15, 20, 25, 50, 75, 100, 125, 150, 175, 200, 225, 250, 275, 300, 325, 350, 375, 400, 425, 450, 475, 500, 525, 550, 575, or 600 micrometers (μm), a thickness included in a range between any two of the above values, or a thickness included in a range bounded on either a minimum or maximum end by one of the above values.

A wide variety of suitable materials and/or combinations of materials may be utilized to form extruded thermoplastic insulation. Examples of suitable materials include, but are not limited to, polyaryletherketone (“PAEK”) including polyetheretherketone (“PEEK”) and/or other PAEK materials, polyetherketoneketone (“PEKK”), polyetheretherketoneketone (“PEEKK”), polyetherketone (“PEK”), other suitable polymers that include at least one ketone group in one of repeat units in one macromolecule and/or their copolymers, polyetherimide (“PEI”) such as Ultem® marketed by Sabic Global Technologies, polyphenylsulfone (“PPSU”) such as Radel® marketed by Solvay Specialty Polymers USA, poly(esterimides), polyethersulfone (“PESU”), polyphenylene sulfide (“PPS”), polybenzimidazole (“PBI”), silicone polymers, polyurethane, polyurea, polycarbonate, one or more polyesters (e.g., poly-1,4-cyclohexylene-dimethylene terephthalate (“PCDT”), polyethylene terephthalate (“PET”), polytrimethylene terephthalate (“PTT”), polybutylene terephthalate (“PBT”), etc.), one or more copolyesters, polyamide, thermoplastic polyimide (“TPI”), one or more acrylic polymer materials, one or more fluoropolymers, polystyrene, and/or various copolymers of multiple materials. In certain embodiments, a thermoplastic insulation layer may be formed from a blend of two or more polymeric materials.

In certain embodiments, a plurality of thermoplastic insulation layers may be formed around a conductor 175. In certain embodiments, a plurality of thermoplastic layers may be formed simultaneously via a single co-extrusion process. In other embodiments, a plurality of separate extrusion steps may be utilized to form successive layers. Additionally, in certain embodiments, if multiple layers of thermoplastic insulation are formed, each layer may be formed from the same polymeric material or matrix polymeric material. For example, multiple layers of PEEK insulation may be formed. As another example, a first PEEK layer may include PEEK with one or more additives while a second layer includes unfilled PEEK. As yet another example, a first PEEK layer may include one or more first additives while a second layer includes one or more second additives that are different from the first additives and/or that are added at different load factors than the first additives. In other embodiments, at least two layers of thermoplastic insulation may be formed from or may include different polymeric materials. For example, a first layer may include PPSU while a second layer includes PEEK. It will be appreciated that any suitable thermoplastic layers or combination of thermoplastic layers may be incorporated into a magnet wire insulation system. Additionally, it will be appreciated in certain embodiments that one or more thermoplastic layers may be combined with one or more other types of insulation, such as one or more enamel layers.

In addition to the additives described in greater detail below that mitigate copper poisoning, in various embodiments, one or more additional additives may be incorporated into an extruded thermoplastic insulation layer. For example, in certain embodiments, one or more compatibilizers and/or coupling agents may be added to a polymeric material or a polymeric blend in order to improve the interactions of the ingredients composed of the material or polymeric blend or composites. As another example, one or more fluoropolymers, such as polytetrafluoroethylene (“PTFE”) or perfluoroethylene-propylene copolymer (“FEP”) may be blended, mixed, added, or otherwise incorporated into an extruded insulation layer. As yet another example, one or more suitable filler materials may be added to a polymeric material utilized to form an extruded insulation layer. Examples of suitable filler materials include, but are not limited to, suitable inorganic materials and/or inorganic materials intended to enhance corona resistance, PDIV, breakdown voltage, and/or one or more thermal properties (e.g., temperature resistance, cut-through resistance, heat shock, etc.). The particles of a filler material may have any suitable dimensions, and any suitable blending ratio or fill rate between filler material and polymeric materials may be utilized (e.g., a fill rate of approximately 3, 5, 10, 15, 20, 25, 30, or 40 percent, or a fill rate included in a range between any of these values). Additionally, if a filler includes a blend of different materials, any suitable blending ratio may be utilized between the components of the filler.

In the event that a thermoplastic layer is formed from a polymeric material that is a blend, two or more component polymeric materials may be blended or mixed together at any suitable blend rates or ratios within the blend. For example, each component may constitute between approximately 1.0% and approximately 99% by weight of a polymeric blend. In certain embodiments, each component material incorporated into a blend (e.g., a first component material, a second component material, etc.) may constitute approximately 5, 10, 15, 20, 25, 30, 40, 45, 50, 60, 70, 75, 80, 90, or 95% by weight of the blend, a weight percentage included in a range between any two of the above values (e.g., between approximately 5 and 95%, between approximately 10 and 90%, etc.), or a weight percentage included in a range bounded on either a minimum or maximum end by one of the above values (e.g., at least 5%, at least 10%, no more than 95%, no more than 90%, etc.). Component materials and relative amounts of materials incorporated into a blend may be selected based on a wide variety of suitable factors including, but not limited to, costs of the materials, processing characteristics, desired dielectric breakdown voltage (“DBV”), desired partial discharge inception voltage (“PDIV”), desired cut-through dimension, desired thermal aging properties, desired temperature rating, desired crystallinity, desired flexibility, desired adhesion, etc.

Additionally, in certain embodiments, a base insulation layer 180 (which may be the only insulation layer or a first insulation layer formed closest to the conductor 175) may be formed directly on the conductor 175. In other words, the base insulation layer 180 may be formed on the conductor 175 without the use of a bonding agent, adhesion promoter, or adhesive layer. For example, the base insulation layer 180 may be formed from a polymeric material that provides a desired adhesion. In other embodiments, one or more suitable primer, bonding agents, adhesion promoters, or adhesive layers may be incorporated between the base insulation layer 180 and the conductor 175. A wide variety of suitable adhesion promoters may be utilized as desired. In yet other embodiments, an adhesion promoting layer may be considered an insulation layer. Regardless of whether an adhesion promoting layer is considered an insulation layer, as desired, one or more additives that mitigate copper poisoning may be optionally incorporated into the adhesion promoting layer.

In other embodiments, one or more suitable surface modification treatments may be utilized on a conductor 175 and/or any number of insulation layers to promote adhesion with a subsequently formed layer. For example, a surface of a conductor or insulation layer may be modified by a suitable treatment in order to promote adhesion with a subsequently formed insulation layer. Examples of suitable surface modification treatments include, but are not limited to, plasma treatment, ultraviolet (“UV”) treatment, electron beam (“EB”) treatment, radiation treatment, ultrasonic treatment, a corona discharge treatment, gas flame treatment, physical vapor deposition (“PVD”), chemical cleaning, chemical etching, chemical vapor deposition (“CVD”), and/or electrochemical deposition. A surface treatment may alter a topography of a conductor or insulation layer and/or form functional groups on the surface of the conductor or insulation layer that enhance or promote bonding of a subsequently formed insulation layer. As a result, surface treatments may reduce interlayer delamination.

Additionally, in embodiments that incorporate a plurality of insulation layers, any suitable ratio or ratios of thicknesses may be utilized between the various layers. Using an example of an insulation system having two insulating layers, the first layer may constitute any suitable percentage (e.g., 1-99%, at least 50%, etc.) of the overall thickness of the combined insulation, and the second layer may constitute any suitable percentage of the overall thickness. As desired, thickness ratios of insulating layers may be selected in order to satisfy a wide variety of suitable design parameters. For example, desired electrical performance may be balanced against the cost of materials utilized to form the insulation layers.

The insulation materials incorporated into a magnet wire 170 may be selected in order to achieve a wide variety of suitable properties and/or characteristics. For example, polymeric materials and/or various combinations of polymeric materials may be selected in order to achieve a desired thermal classification (or thermal class), thermal index, and/or thermal endurance. Thermal classes, which are generally established by industry standards organizations (e.g., the National Electric Manufacturers Association, the International Electrotechnical Commission, UL, etc.), establish maximum allowable temperatures for an insulation material and/or magnet wire. Example thermal classes include, for example, 150° C., 180° C., 200° C., 220° C., and 240° C. A thermal index is generally defined as a number in degrees Celsius that compares the temperature vs. time characteristics of an electrical insulation material. It may be obtained by extrapolating the Arrhenius plot of life versus temperature to a specified time, usually 20,000 hours. As an example of the difference between a thermal class and a thermal index, a material may have a thermal index of 230° C.; however, that material will have a thermal class of 220° C. as it does not meet the requirements of the next available thermal class of 240° C. As another example, polymeric materials may be selected based upon their physical properties (e.g., whether a thermoplastic material is amorphous, crystalline, semi-crystalline, etc.), shrinkage characteristics, resistance to certain fluids (e.g., transmission fluid), partial discharge inception voltage, dielectric strength, and/or any other suitable characteristics.

In certain embodiments, an insulation system formed on a magnet wire 170 may have a wide variety of suitable electrical performance parameters, such as a wide variety of suitable PDIV values and/or dielectric strength or breakdown strength values. In certain embodiments, an insulation system may provide a PDIV value at 25° C. of at least approximately 800, 900, 1000, 1100, 1200, 1250, 1300, 1350, 1400, 1450, 1500, 1550, 1600, 1700, 1800, 1900, 2000, 2100, 2200, 2300, or 2400 volts, or a PDIV value included in a range between any two of the above values. Similarly, in certain embodiments, an insulation system may provide a dielectric strength value (e.g., a dielectric strength value measured by a suitable industry standard test such as a shotbox or foil test, etc.) of at least approximately, 10,000, 11,000, 12,000, 12,500, 13,000, 13,500, 14,000, 14,500, 15,000, 15,500, 16,000, 16,500, 17000, 17,500, 18,000, 18.500, 19,000, 20,000, 20,500, or 21,000 volts, or a dielectric strength value included in a range between any two of the above values. Other suitable performance parameters may be targeted and/or achieved as desired.

Regardless of the insulation system formed on a magnet wire, according to an aspect of the disclosure, one or more fillers or additives that mitigate copper poisoning may be incorporated into any desired number of insulation layers and into at least one thermoplastic insulation layer. For example, one or more additives may be incorporated into an insulation layer 180 positioned closest to the conductor 175 (e.g., a base insulation layer formed directly on a conductor, etc.). As another example, one or more additives may be incorporated into a plurality of insulation layers 180, 185 positioned closest to the conductor 175.

As desired in various embodiments, a wide variety of different additives and/or combinations of additives may be incorporated into one or more insulation layers to mitigate copper poisoning. The additives may include, but are not limited to, additives that function as acid scavengers (e.g., strong bases, weak bases, metal oxides, etc.), antioxidants, additives that function as thermal stabilizers, and/or chemical cross-linking additives.

An acid scavenger may include any suitable additive that helps to neutralize acids or acidic materials. It is assumed that the polymer materials utilized in insulation may be oxidized at elevated temperatures and/or decomposed to generate acidic chemical species, thereby resulting in their strong interactions with copper ions, which speed up the mobility of copper cations in the polymer materials. For example, a ketone group (—CO—) in PEEK may oxidize into carboxylic acid (—COOH) at elevated temperature. The carboxyl group will react with copper and create electrochemical gradient near the copper-polymer interface, which generates the potential for copper migrations into the polymer matrix.

A wide variety of suitable acid scavengers may be utilized as desired in various embodiments including, but not limited to, strong bases, weak bases, metal oxides, and/or other suitable materials. Examples of suitable strong bases that may be utilized include, but are not limited to, lithium hydroxide, magnesium hydroxide (“Mg(OH)₂”), calcium hydroxide (“Ca(OH)₂”), barium hydroxide, and/or hydrates of these materials (e.g., lithium hydroxide monohydrate (“LiOH·H₂O”), barium hydroxide hydrate (“Ba(OH)₂·xH₂O”), barium hydroxide octahydrate (“Ba(OH)₂·8H₂O”), etc.).

Examples of suitable weak bases include, but are not limited to, aluminum hydroxide (“Al(OH)₃”), zirconium (IV) hydroxide (“Zr(OH)₄)”), zirconium (IV) carbonate hydroxide oxide (“Zr(OH)₂CO₃·ZrO₂”), aluminum dihydrogen phosphate (“Al(H₂PO₄)₃)”), sodium hydrogen phosphate (“Na₂HPO₄”), lead (II) hydroxide acetate (also known as lead (II) acetate basic or (“CH₃COO)₂Pb·Pb(OH)₂”), ammonium bicarbonate (“NH₄HCO₃”), calcium phosphosilicate, and/or molecular sieves (e.g., molecular sieves 3A, KₙNa₁₂₋ₙ[(AlO₂)₁₂(SiO₂)₁₂]·xH₂O). In preliminary evaluations, as set forth in the examples below, certain weak bases have shown promising results at mitigating copper poisoning. Other potentially useful weak base materials include sodium carbonate (“Na₂CO₃”), potassium carbonate (“K₂CO₃”), sodium bicarbonate (“NaHCO₃”), sodium benzoate (“C₆H₅COONa”), calcium carbonate (“CaCO₃”), an aluminum hydroxide complex (e.g., “Al(OH)₃”), etc.), and/or zinc acetate dihydrate (“Zn(OOCCH₂)₂·2H₂O”).

Examples of suitable metal oxides (which are a particular type of weak base) that may be utilized as acid scavengers include, but are not limited to, vanadium (V) oxide (“V₂O₅”), barium oxide (“BaO”), magnesium oxide (“MaO”), calcium oxide (“CaO”), zirconia (“ZrO₂”), titania (“TiO₂”), alumina-treated titania (“Al₂O₃@TiO₂”), and/or ceria-treated zirconia (“CeO₂@ZrO₂”). Other potentially useful metal oxides include zinc oxide (“ZnO”), alumina (“Al₂O₃”), and/or antimony tin oxide (“ATO”). A wide variety of other suitable acid scavengers may be utilized as desired in other embodiments.

In certain embodiments, one or more thermal stabilizers, such as antioxidants and/or or thermal stabilizers, may be used as additives to mitigate copper poisoning. For certain polymeric materials utilized to form insulation (e.g., PEEK, etc.), it may be beneficial to have a relatively high thermal stability. An antioxidant may include a suitable additive that inhibits or counteracts oxidation. Examples of suitable antioxidants that may be utilized in various embodiments include, but are not limited to, triaryl phosphate, aromatic phosphite, one or more hindered phenol-type antioxidants, one or more secondary aromatic amines, and/or one or more free-radical scavengers. In certain embodiments, a hindered phenol-type antioxidant may include tetrakis(2,4-di-tert-butylphenyl) [1,1-biphenyl]-4,4′diylbisphosphonite, pentaerythritol tetrakis(3-(3,5-di-tert-butyl-4-hydroxyphenyl) propionate), N,N′-(hexane-1,6-diyl) bis(3-(3,5-di-tert-butyl-4-hydroxyphenylpropionamide)), octyl-3,5-di-tert-butyl-4-hydroxy-hydrocinnamate, (ethane-1,2-diylbis(oxy))bis(ethane-2,1-diyl) bis(3-(3-(tert-butyl)-4-hydroxy-5-methylphenyl) propanoate), pentaerythritol tetrakis(3,5-di-tert-butyl-4-hydroxyhydrocinnamate), octadecyl 3-(3,5-di-tert-butyl-4-hydroxyphenyl) propionate, benzenepropanoicacid-5-bis(1,1-dimethylethyl)-4-hydroxy-2-[3-[3,5-bis(1,1-dimethylethyl)-4-hydroxyphenyl]-1-oxopropyl]hydrazide, tris(3,5-di-tert-butyl-4-hydroxybenzyl) isocyanurate, 2,4,6-tris(3′,5′-di-tert-butyl-4′-hydroxybenzyl) mesitylene, ethane-1,2-diylbis(oxy))bis(ethane-2,1-diyl) bis(3-(3-(tert-butyl)-4-hydroxy-5-methylphenyl)propanoate), 4,4′,4″-((2,4,6-trimethylbenzene-1,3,5-triyl) tris(methylene)) tris(2,6-di-tert-butylphenol), 4-((4,6-Bis(octylthio)-1,3,5-triazin-2-yl)amino)-2,6-di-tert-butylphenol, calcium ethyl 3,5-di-tert-butyl-4-hydroxybenzylphosphonate, poly(dicyclopentadiene-co-p-cresol), 2-Methyl-4,6-bis((octylthio) methyl) phenol, 3,3′,3′,5,5′,5′-hexa-tert-butyl-a,a′,a′-(mesitylene-2,4,6, triyl) tri-p-cresol, 2-(1,1-dimethylenyl)-6-[3-(1,1-dimethylethyl)-2-hydroxy-5-methylphenyl]methyl-4-methylphenyl acrylate, 3-(1,1-Dimethylethyl)-4-hydroxy-5-methyl-benzene propanoic acid 2,4,8,10-tetraoxaspiro [5.5]undecane-3,9-diylbis(2,2-dimethyl-2,1-ethane diyl) ester, benzenepropanoic acid, 3, 5-bis(1,1-dimethylethyl)-4-hydroxy-, C7-C9 branched alkyl esters, or another suitable material. Phosphorus antioxidants may include, for example, aryl phosphates such as triphenyl phosphate (TPP), tricresyl phosphate (TCP), isopropylate triphenyl phosphate) (IPTPP), butylated triphenyl phosphate (BTPP), cresyl diphenyl phosphate, trixylenyl phosphate (TXP), tertiary butyl phenyl phenyl phosphates, ethyl phenyl dicresyl phosphate, isopropylphenyl diphenyl phosphate, phenyl-bis(4-alpha-methylbenzylphenyl) phosphate. Phophorous antioxidants may also include, but are not limited to, aryl phosphites, such as triphenyl phosphite, tritolyl phosphite, tris(2,4-di-tert-butylphenyl) phosphite. Aromatic secondary amines may include substituted-p-phenylenediamines (PPD) such as N-1,3-dimethylbutyl-N′-phenyl-p-phenylenediamine (6PPD), N,N′-bis-(1,4-dimethylpentyl)-p-phenylenediamine (77PD), N,N′,N″-Tris {4-[(5-methyl-2-hexanyl)amino]phenyl}-1,3,5-triazine-2,4,6-triamine (PPDTZ), N,N,N,N-tetramethyl-p-phenylenediamine (TMPPD), N,N′-diphenyl-1,4-phenylenediamine (DPPD), N-phenyl-N′-isopropyl-p-phenylene diamine (IPPD), N-phenyl-N′-(α-methylbenzyl)-p-phenylenediamine (SPPD), tris-(N-dimethylpentyl-p-phenylenediamine)-N,N,N-1,3,5-triazine (6PPDTZ), N,N′-(hexane-1,6-diyl) bis(3-(3,5-di-tert-butyl-4-hydroxyphenyl) propanamide), 4,4-bis(α,α-dimethylbenzyl) diphenylamine. Other potentially useful antioxidants include one or more peroxide scavengers.

Examples of other thermal stabilizers, heat stabilizers, or metal inactivators that may be utilized include, but are not limited to, iron (II) oxalate hydrate (“Fe(C₂O₄)₂·xH₂O”), 2-Hydroxy-N-1H-1,2,4-triazol-3-ylbenzamide; N′1,N′12-Bis(2-hydroxybenzoyl) dodecanedihydrazide; 1,3,5-Triazine-2,4,6-triamine, 2,2′-Oxamidobis [ethyl-3-(3,5-di-t-butyl-4-hydroxyphenyl) propionate], ferrocene and/or its organometallic derivatives including, for example, ethylferrocene, buylferrocene, acetylferrocene, ferrocenemethanol, (dimethylaminomethyl) ferrocene, 1,1′-bis(dicyclohexylphosphino) ferrocene, 1′-bis(phenylphosphinidene) ferrocene. Other potentially useful materials include one or more copper organic compounds such as copper acetylacetonate, copper phthalocyanine, chlorinated copper phthalocyanine, copper (II) 2,3-naphthalocyanine, 5,10,15,20-tetraphenyl-21H,23H-porphine copper (II), 2,3,7,8,12,13,17,18-Octaethyl-21H,23H-porphine copper (II), copper (II) 4,4′,4″,4″-tetraaza-29H,31H-phthalocyanine; and/or one or more aromatic fluids having relatively high boiling points (e.g., boiling points above approximately 280° C.).

Examples of suitable chemical crosslinkers that may be utilized as additives to mitigate copper poisoning include, but are not limited to, polyamideimide, aromatic bismaleimide (“1,1′-(Methylenedi-4,1-phenylene)bismaleimide”), aromatic c (e.g., “bisphenol A benzoxazine”), epoxy novolac resin, epoxy resin of phenol-dicyclopentadiene adducts, aromatic amine, 4,4′-Diaminodiphenyl sulfone, and/or carbodilite. Other materials that have been evaluated include phenolphthalein, melamine, and diphenyl-p-phenylenediamine, 1,3-phenylene-bis-oxazoline, Di-(o-tosyl) carbodiimide, trimethylolpropane tris(2-methyl-1-aziridinepropionate, and trimer of toluene disocyanate. In yet other embodiments, any suitable combination of additives may be utilized, such as any of the additives discussed above.

A wide variety of other suitable additives may be utilized as desired. In certain embodiments, a suitable additive may include a material that facilitates higher crystallinity of a polymeric matrix for certain materials (e.g., PEEK or other crystalline or semi-crystalline thermoplastic materials, etc.), slower oxidation in the insulation layer (e.g., slower formation of chemical groups of —C═O or —COOH in PEEK molecules or other polymer molecules, etc.), and/or higher dielectric breakdown voltage or dielectric strength for copper magnet wires. In certain embodiments, one or more desired criteria may be measured or evaluated utilizing a wide variety of suitable parameters, such as evaluating an insulated magnet wire 170 after it is maintained at 150° C. for 500 to 1000 hours while being exposed to air.

In certain embodiments, a single additive may be incorporated into an insulation layer. In other embodiments, a combination of additives or a blend of multiple additives may be utilized. In the event that a combination of additives is incorporated, any suitable blending ratio of additives may be utilized. For example, each additive may constitute approximately 0.3, 0.5, 1, 5, 10, 15, 20, 25, 30, 40, 50, 60, 70, 75, 80, 90, 95, or 95% of an additive blend, or a percentage included in a range between any two of the above values.

Additionally, any suitable loading factors of additives may be utilized as desired. In other words, any suitable weight percentage of additives may be incorporated into an insulation layer (e.g., layer 180). In certain embodiments, the additives may constitute between approximately 0.1 percent (0.1%) and approximately forty percent (40%) by weight of an insulation layer. For example, the additives may constitute between approximately 0.3 percent (0.3%) and approximately thirty percent (30%) by weight of an insulation layer, between approximately 0.3 percent (0.3%) and approximately twenty-five percent (25%) by weight of an insulation layer, between approximately 0.3 percent (0.3%) and approximately fifteen percent (15%) by weight of an insulation layer, between approximately 0.3 percent (0.3%) and approximately ten percent (10%) by weight of an insulation layer, or between approximately 0.3 percent (0.3%) and approximately five percent (5%) by weight of an insulation layer. In various embodiments, the additives may constitute approximately 0.1, 0.3, 0.5, 1.0, 1.5, 2.0, 2.5, 3.0, 4.0, 5.0, 6.0, 7.0, 8.0, 9.0, 10.0, 12.0, 15.0 18.0, 20.0, 22.0, 25.0, 28.0, 30.0, 35.0, or 40.0 percent by weight of an insulation layer, a weight percentage included in a range between any two of the above values, or a weight percentage included in a range bounded on the maximum end by one of the above values. Further, different additives and/or additive types may be incorporated into an insulation layer at differing weight percentage in order to achieve desired mitigation of copper poisoning.

In various embodiments, one or more additives that function as acid scavengers may have a fill rate between approximately one percent (1.0%) and approximately twenty percent (20.0%) by weight of an insulation layer, such as a fill rate between approximately one percent (1.0%) and approximately ten percent (10.0%) by weight of an insulation layer. For example, a strong base additive, a weak base additive, or a metal oxide additive may have a fill rate between approximately one percent (1.0%) and approximately twenty percent (20.0), such as a fill rate between approximately one percent (1.0%) and approximately ten percent (10.0%) by weight of an insulation layer. In various embodiments, one or more thermal stabilizer additives may have a fill rate between approximately one-half of one percent (0.5%) and approximately ten percent (10.0%) by weight of an insulation layer, such as a fill rate between approximately one-half of one percent (0.5%) and approximately five percent (5.0%) by weight of an insulation layer. In various embodiments, one or more chemical crosslinker additives may have a fill rate between approximately one-half of one percent (0.5%) and approximately thirty percent (30.0%) by weight of an insulation layer, such as a fill rate between approximately one percent (1.0%) and approximately twenty-five percent (25.0%) by weight of an insulation layer. A few specific examples of different weight percentages being utilized for different additives are illustrated in the Examples below.

A wide variety of suitable methods or techniques may be utilized as desired to incorporate one or more additives into an insulation layer to mitigate copper poisoning. As one example, for an insulation layer formed from a thermoplastic polymeric material (e.g., PEEK, etc.), one or more additives may be compounded into a matrix or base polymeric material prior to extrusion. For example, one or more additives may be added, mixed, or blended into a polymeric matrix material or into a polymeric resin in a suitable thermoplastic compounding device, such as a single screw extruder, a twin screw extruder, or a Brabender mixer. In other embodiments, one or more additives may be incorporated into a solution that is added to a matrix polymeric material prior to extrusion. The polymeric material containing the additive(s) may then be extruded onto a magnet wire 170 to form a thermoplastic insulation layer. The additives may have any suitable particle sizes. In certain embodiments, one or more additives may include microparticles and/or nanoparticles. As desired, one or more additives may be milled or otherwise processed to reduce their particle sizes prior to incorporation into a matrix polymeric material.

In yet other embodiments, one or more additives may be deposited onto or coated onto an insulation layer or onto a conductor. For example, one or more additives may be deposited onto a conductor prior to an extruded thermoplastic insulation layer being formed around the conductor. As another example, one or more additives may be deposited onto an underlying insulation layer that has been formed around a conductor prior to an additional insulation layer being formed.

As a result of incorporating one or more additives into magnet wire insulation to mitigate copper poisoning, decomposition of the insulation may be reduced, limited, or suppressed. In certain embodiments, delamination of extruded thermoplastic insulation may also be reduced or limited and/or oxidation of the conductor may be reduced or limited. Further, the long-term electrical performance of the magnet wire 170 may be improved. For example, the thermal endurance of the magnet wire 170 may be improved, especially at elevated temperatures and/or in the presence of auto transmission fluid or other fluids. Further, in certain embodiments, magnet wire including thermoplastic insulation formed directly around a conductor may have enhanced electrical performance, such as enhanced partial discharge inception voltage (“PDIV”) and/or enhanced dielectric strength or dielectric breakdown voltage.

In certain embodiments, magnet wire 170 including thermoplastic insulation (e.g., PEEK insulation, etc.) formed directly around a conductor 175 may have enhanced electrical performance, such as performance that similar to or that exceeds conventional magnet wire having thermoset or thermosetting insulation formed directly on the conductor (e.g., magnet wire having polyimide (“PI”) or polyamideimide (“PAI”) enamel insulation, etc.). In other words, the additives incorporated into the thermoplastic insulation reduce or limit decomposition of the insulation due to copper poisoning and/or may reduce or limit delamination or loss of adhesion, thereby making it more viable to form thermoplastic insulation directly on a magnet wire conductor 175. As a result, in certain embodiments, it may be possible to avoid the use of base thermoset insulation and/or adhesion layers under thermoplastic insulation. In some cases, such a design may reduce the overall cost of magnet wire 170 while allowing the wire to have desired electrical performance characteristics. For example, a magnet wire 170 may be formed with PEEK insulation extruded directly on a conductor 175, and the magnet wire 170 may have an electrical performance similar to or higher than conventional magnet wire including PI, PAI or other enamel insulation, or a combination of enamel base insulation and PEEK topcoat insulation.

The magnet wires 100, 120, 150, 170 described above with reference to FIGS. 1A-1D are provided by way of example only. A wide variety of alternatives could be made to the illustrated magnet wires 100, 120, 150, 170 as desired in various embodiments. For example, a different number of insulation layers may be utilized than those that are illustrated. As another example, the cross-sectional shape of a magnet wire and/or one or more insulation layers may be altered. Indeed, the present disclosure envisions a wide variety of suitable magnet wire constructions.

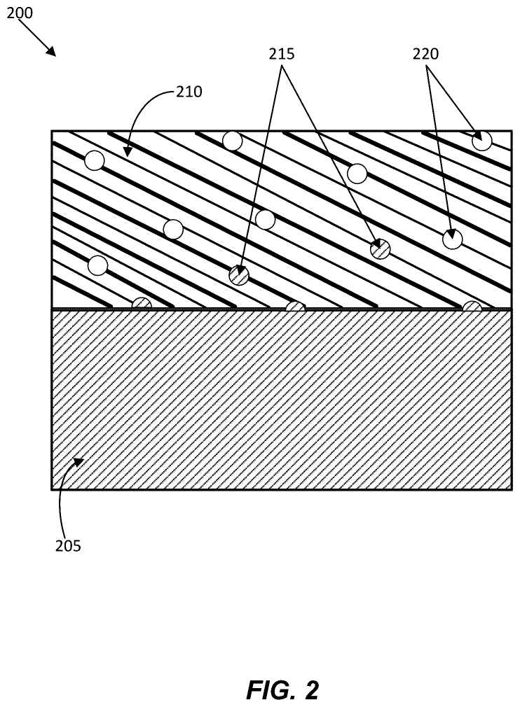

FIG. 2 depicts a schematic illustration 200 of the suppression of copper poisoning as a result of incorporating one or more additives into magnet wire insulation, according to an illustrative embodiment of the disclosure. The illustration 200 depicts a cross-sectional representation of an example copper conductor 205 coated with at least one insulation layer 210 that may be utilized for a magnet wire, such as any of the magnet wires 100, 120, 150, 170 depicted in FIGS. 1A-1D. Following formation of the magnet wire, oxidation or other conditions may cause copper ions 215 within the conductor 205 to migrate or attempt to migrate into the insulation layer 210. However, one or more additives 220 incorporated into the insulation layer, such as any of the example additives described above with reference to FIG. 1D, may mitigate, suppress, limit, and/or prevent migration of the copper ions 215 into the insulation layer 210. As a result, decomposition of the insulation layer 210 may be reduced, limited, or prevented. Additionally, the electrical performance of the insulation layer 210 may be improved.

### EXAMPLES

The following examples are intended as illustrative and non-limiting, and represent specific embodiments of the present invention. The samples illustrate the observed and measured effects of incorporating various additives into extruded thermoplastic polymeric materials to mitigate copper poisoning. Each of the samples was prepared by incorporating a suitable additive into a PEEK polymeric material. To simulate a magnet wire construction and to more easily evaluate the additives, molded films of insulation were prepared by press molding the films onto copper sheets with clean, free of oxidation surfaces. Powder from PEEK resin material with different additives were first compression molded into polymer film with PEEK as a matrix material and having a thickness of approximately 160 microns. Then, for each of the various samples, a PEEK insulation film (with different additives) was hot pressed onto a 3 mil (0.0762 mm) copper sheet which was sandwiched between two polytetrafluoroethylene (“PTFE”) coated glass fabric cloths with two stainless steel plates positioned on the top and bottom sides. For each sample, a lab press was preheated to approximately 690° F. (approximately 365° C.). The two stainless steel plates and PTFE coated glass fabric cloths with the copper sheet and polymer film sandwiched between them were loaded onto the press, and the press was held at a pressure of approximately two tons for approximately two minutes to facilitate good contact of the PEEK insulation film onto the copper sheet. The press was then cooled to approximately 300° F. (approximately 149° C.) before being released.

During the forming of the various PEEK materials for the samples, various additives were incorporated into the matrix of PEEK polymeric material by mechanical mixing. The additives were evaluated for compatibility and uniformity of dispersion when incorporated into the matrix polymeric resin before and after hot compression into polymer films. A “good” compatibility of an additive to the polymer matrix was indicated when the additive dispersed uniformly into the polymer matrix, which can be observed by the apparent color difference between the additive and the polymer matrix. Additionally, the processibility of the mixture for forming a press molded film layer was evaluated. A “good” processibility of the polymer mixture (e.g., a polymer matrix with an additive) was defined by good melt flow of both additive and the polymer matrix during hot compression, which resulted in the additive being uniformly dispersed into the polymer matrix. On the other hand, “poor” processibility of a polymer mixture was observed when an additive was nonuniformly dispersed into the polymer matrix and also if other visible defects or unacceptable film thickness variation occurred due to poor melt flow of the polymer mixture during hot compression.

Following preparation of the samples with PEEK layers on copper sheets, each sample was aged for approximately one week (e.g., 168 hours) at approximately 150° C. in an air environment. Each sample was then evaluated for thermal stability of the copper substrate and appearance of copper color change due to oxidation (i.e., oxidation to a dark color from generation of copper ionic species that ultimately results in copper ion migration to the polymer insulation film layer). Compared to “normal oxidation” for the control sample of a PEEK film without any additive, “slow oxidation” resulted in less color change for the copper surface against the polymer film of PEEK with a certain additive. On the other hand, “fast oxidation” corresponded to a darker color change of the copper surface against the polymer film with a certain additive. In particular, each sample was compared to a control sample including PEEK without any additives. A determination was then made as to whether the sample experienced oxidation similar to, slower than, or faster than the control.

Further, when each sample is made, the partial discharge inception voltage (“PDIV”) and dielectric breakdown voltage (“DBV”) of the insulation are determined. The PDIV and dielectric breakdown voltages of the insulation are determined again after aging is completed, and a change in the PDIV and dielectric breakdown voltage is calculated for each sample. In this regard, a determination can be made as to how certain additives impact certain electrical performance criteria of a magnet wire as the extruded insulation interacts with the copper conductor over time. Each PDIV measurement was determined utilizing a SOKEN DAC-6021 Partial Discharge Measuring System produced by Soken Electric Co., Ltd. An aluminum foil was positioned on an opposite side of the insulation from the copper sheet, and electrodes were then attached to the aluminum foil and the copper with the polymer film sandwiched between them. At a test frequency of 60 Hz and at 25° C., an initial voltage of 400V was applied to the electrodes, and the voltage was ramped at 100V per second with an upper limit of 3000V. The PDIV was then calculated by the Measuring System.

Each dielectric breakdown voltage was determined using a NOVA 14001-LCT dielectric breakdown test made commercially available by Ampac International Inc. An aluminum foil was positioned on an opposite side of the insulation from the copper sheet with the polymer film sandwiched between them, and electrodes were attached to the foil and the copper. A voltage was then applied to the electrodes at 25° C. and increased at a 500V per second ramp rate until the insulation failed.

Table 1 below illustrates test results for certain alkaline or base additives incorporated into thermoplastic PEEK insulation including certain strong bases, weak bases, and metal oxides. Certain example additives were found to have desirable properties. Other additives failed one or more tests or were found to have generally undesirable properties, and these other additives are provided in Table 1 as Comparative Examples. However, it should be appreciated that certain Comparative Examples provide benefits when added to PEEK insulation, such as slower oxidation and/or improved electrical performance. Additionally, the results of a control sample of PEEK with no additives are provided.

TABLE 1
Acid Scavenger Additives in PEEK Insulation

| | | Compat. | | Thermal | | |
|---|---|---|---|---|---|---|
| | | Of | | Stability and | Change in | |
| | Additive | Additive | | Observed | PDIV | Change in |
| | Content | in PEEK | | Change due | After | DBV After |
| Additive | (wt %) | Resin | Processibility | to Oxidation | Aging | Aging |
| Control | 0 | Good | Good | Normal | +3.00% | −0.38% |
| (None) | | | | Oxidation | | |
| Lithium | 3.84% | Good | Good | Slow | +32.9% | +3.88% |
| hydroxide | | | | Oxidation | | |
| monohydrate | | | | | | |
| Lead(II) | 7.37% | Good | Good | Slow | +17.37% | +37.9% |
| hydroxide | | | | Oxidation | | |
| acetate | | | | | | |
| Calcium | 3.86% | Good | Good | Slow | +8.67% | +4.63% |
| phosphosilicate | | | | Oxidation | | |
| Ammonium | 16.67% | Good | Fair | Slow | +7.37% | +22.0% |
| bicarbonate | | | | Oxidation | | |
| Barium | 3.85% | Good | Good | Slow | −6.28% | +77.0% |
| hydroxide | | | | Oxidation | | |
| octahydrate | | | | | | |
| Molecular | 7.51% | Good | Fair | Slow | −7.99% | +222.7% |
| Sieves 3A | | | | Oxidation | | |
| Zirconium(IV) | 7.35% | Good | Good | Slow | −0.65% | +32.7% |
| carbonate | | | | Oxidation | | |
| hydroxide oxide | | | | | | |
| Vanadium(V) | 7.41% | Good | Good | Slow | +23.3% | +91.6% |
| oxide | | | | Oxidation | | |
| (microparticles) | | | | | | |
| Titania | 7.41% | Good | Good | Slow | +7.67% | +4.27% |
| (microparticles) | | | | Oxidation | | |
| Zirconia | 7.40% | Good | Good | Slow | +4.33% | +17.6% |
| (microparticles) | | | | Oxidation | | |
| Titania | 7.41% | Good | Fair | Slow | +0.17% | +35.1% |
| (nanoparticles) | | | | Oxidation | | |

Comparative Examples

| | | | | | | |
|---|---|---|---|---|---|---|
| Sodium benzoate | 7.40% | Good | Good | Normal | | |
| | | | | Oxidation | | |
| Sodium | 3.90% | Good | Good | Normal | | |
| carbonate | | | | Oxidation | | |
| Alumina-treated | 7.38% | Good | Good | Slow | −7.01% | −19.4% |
| titania | | | | Oxidation | | |
| Ceria-treated | 7.43% | Good | Good | Slow | −8.12% | −5.57% |
| ZrO₂ | | | | Oxidation | | |
| Zinc Oxide | 7.44% | Good | Good | Slow | −2.87% | +21.2% |
| | | | | Oxidation | | |
| Alumina | 7.42% | Good | Good | Slow | +3.34% | −4.89% |
| | | | | Oxidation | | |
| Antimony doped | 7.40% | Good | Good | Slow | −4.79% | −5.16% |
| tin oxide | | | | Oxidation | | |

As shown in Table 1, certain acid scavenger additives provided particularly beneficial results in both limiting copper poisoning and improving one or more electrical performance characteristics (e.g., PDIV, DBV). It can be concluded that these additives will enhance the performance of magnet wire that includes PEEK or other thermoplastic insulation formed around a conductor.

Table 2 below illustrates test results for certain thermal stabilizers incorporated into thermoplastic PEEK insulation as additives to mitigate copper poisoning. Certain example additives were found to have desirable properties. Other additives failed one or more tests or were found to have generally undesirable properties, and these other additives are provided in Table 2 as comparative examples. Additionally, the results of a control sample of PEEK with no additives are provided.

TABLE 2
Thermal Stabilizer Additives in PEEK Insulation

| | | | | Thermal | | |
|---|---|---|---|---|---|---|
| | | | | Stability | | |
| | | Compat. | | and | | |
| | | Of | | Observed | Change | Change |
| | Additive | Additive | | Change | in PDIV | in DBV |
| | Content | in PEEK | | due to | After | After |
| Additive | (wt %) | Resin | Processibility | Oxidation | Aging | Aging |
| Control | 0 | Good | Good | Normal | +3.00% | −0.38% |
| (None) | | | | Oxidation | | |
| Iron(II) oxalate | 3.91% | Good | Excellent | Slow | +6.07% | +11.5% |
| hydrate | | | | Oxidation | | |
| N,N′-(hexane-1, 6- | 3.83% | Good | Excellent | Slow | +6.55% | −5.03% |
| diyl)bis[3,5-di-tert- | | | | Oxidation | | |
| butyl-4- | | | | | | |
| hydroxyphenyl) | | | | | | |
| propenamide] | | | | | | |

Comparative Examples

| | | | | |
|---|---|---|---|---|
| Tetrakis(2,4-di-tert- | 3.87% | Good | Good | Normal |
| butylphenyl)[1,1- | | | | Oxidation |
| biphenyl]- | | | | |
| 4,4′ diylbisphosphonite | | | | |
| Tris(2,4-di-tert- | 3.80% | Good | Excellent | Normal |
| butylphenyl) | | | | Oxidation |
| phosphite | | | | |
| Phenolphthalein | 7.51% | Good | Excellent | Normal |
| | | | | Oxidation |

As shown in Table 2, certain thermal stabilizer additives provided particularly beneficial results in both limiting copper poisoning and improving one or more electrical performance characteristics (e.g., PDIV, DBV). It can be concluded that these additives will enhance the performance of magnet wire that includes PEEK or other thermoplastic insulation formed around a conductor.

Table 3 below illustrates test results for certain chemical crosslinkers incorporated into thermoplastic PEEK insulation as additives to mitigate copper poisoning. Certain example additives were found to have desirable properties. Other additives failed one or more tests or were found to have generally undesirable properties, and these other additives are provided in Table 3 as comparative examples. Additionally, the results of a control sample of PEEK with no additives are provided.

TABLE 3
Chemical Crosslinker Additives in PEEK Insulation

| | | | | Thermal | | |
|---|---|---|---|---|---|---|
| | | | | Stability | | |
| | | Compat. | | and | | |
| | | Of | | Observed | Change | Change in |
| | Additive | Additive | | Change due | in PDIV | DBV |
| | Content | in PEEK | | to | After | After |
| Additive | (wt %) | Resin | Processibility | Oxidation | Aging | Aging |
| Control | 0 | Good | Good | Normal | +3.00% | −0.38% |
| (None) | | | | Oxidation | | |
| Polyamideimide A | 17.02% | Good | Excellent | Slow | +7.16% | +62.8% |
| (Essex formulation) | | | | Oxidation | | |
| Polyamideimide B | 16.94% | Good | Excellent | Slow | +7.95% | +15.9% |
| (Essex formulation) | | | | Oxidation | | |
| Polyamideimide C | 17.00% | Good | Excellent | Slow | +46.5% | +18.4% |
| (Essex formulation) | | | | Oxidation | | |
| 1,1′-(Methylenedi- | 9.10% | Good | Excellent | Slow | +16.3% | +25.94% |
| 4, 1-phenylene) | | | | Oxidation | | |
| bismaleimide | | | | | | |
| Bisphenol A | 23.09% | Good | Excellent | Slow | +6.35% | +83.0% |
| benzoxazine | | | | Oxidation | | |
| Epoxy of phenol/ | 14.46% | Good | Excellent | Slow | +5.11% | |
| dicyclopentadiene | | | | Oxidation | | |
| adduct | | | | | | |
| Epoxy Novolac | 8.44% | Good | Poor | Slow | +6.11% | |
| Resin | | | | Oxidation | | |
| 4,4′- | 8.32% | Good | Excellent | Slow | | |
| Diaminodiphenyl | | | | Oxidation | | |
| sulfone | | | | | | |

Comparative Examples

| | | | | |
|---|---|---|---|---|
| Melamine | 16.66% | Fair | Excellent | Fast |
| | | | | Oxidation |
| Diphenyl-p- | 9.01% | Good | Excellent | Fast |
| phenylenediamine | | | | Oxidation |
| 1,3-phenylene-bis- | 23.10% | Good | Excellent | Normal |
| oxazoline | | | | Oxidation |
| Di-(o-tosyl) | 23.08% | Good | Excellent | Normal |
| carbodiimide | | | | Oxidation |
| Trimethylol- | 23.37% | Good | Excellent | Fast |
| propane tris(2- | | | | Oxidation |
| methyl-1- | | | | |
| aziridinepropionate) | | | | |
| Trimer of toluene | 3.76% | Fair | Poor | Fast |
| diisocyanate | | | | Oxidation |

As shown in Table 3, certain chemical crosslinker additives provided particularly beneficial results in both limiting copper poisoning and improving one or more electrical performance characteristics (e.g., PDIV, DBV). It can be concluded that these additives will enhance the performance of magnet wire that includes PEEK or other thermoplastic insulation formed around a conductor. Additionally, although the samples included in Tables 1-3 provide for specific additives and fill rates, a wide variety of other suitable additives and/or fill rates may be utilized in other embodiments.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A magnet wire comprising:
a conductor comprising copper; and
at least one insulation layer formed around the conductor, the insulation layer comprising:
a matrix thermoplastic polymeric material; and
one or more additives incorporated into the matrix polymeric material, wherein the one or more additives mitigate copper poisoning.

2. The magnet wire of claim 1, wherein the matrix polymeric material comprises a polymer including at least one ketone group in one of repeat units in one macromolecule.

3. The magnet wire of claim 1, wherein the matrix polymeric material comprises polyetheretherketone.

4. The magnet wire of claim 1, wherein the one or more additives comprise an acid scavenger, the acid scavenger comprising at least one of (i) a strong base, (ii) a weak base, or (iii) a metal oxide.

5. The magnet wire of claim 4, wherein the one or more additives comprise a strong base, the strong base comprising at least one of (i) lithium hydroxide, (ii) magnesium hydroxide, (iii) calcium hydroxide, (iv) barium hydroxide, or (v) a hydrate of lithium hydroxide, magnesium hydroxide, calcium hydroxide, or barium hydroxide.

6. The magnet wire of claim 4, wherein the one or more additives comprise a weak base, the weak base comprising at least one of (i) aluminum hydroxide, (ii) zirconium (IV) hydroxide, (iii) zirconium (IV) carbonate hydroxide oxide, (iv) aluminum dihydrogen phosphate, (v) sodium hydrogen phosphate, (vi) lead (II) hydroxide acetate, (vii) ammonium bicarbonate, (viii) calcium phosphosilicate, or (ix) molecular sieves.

7. The magnet wire of claim 4, wherein the one or more additives comprise a metal oxide, the metal oxide comprising at least one of (i) vanadium (V) oxide, (ii) barium oxide, (iii) magnesium oxide, (iv) calcium oxide, (v) zirconia, or (vi) titania.

8. The magnet wire of claim 1, wherein the one or more additives comprise a thermal stabilizer, the thermal stabilizer comprising at least one of (i) triaryl phosphate, (ii) aromatic phosphite, (iii) a secondary aromatic amine, (iv) a free-radical scavenger, (v) iron (II) oxalate hydrate, (vi) ferrocene, or (vii) a derivative of ferrocene.

9. The magnet wire of claim 1, wherein the one or more additives comprise a chemical crosslinker, the chemical crosslinker comprising at least one of (i) polyamideimide, (ii) aromatic bismaleimide, (iii) aromatic benzoxazine, (iv) epoxy novalac resin, (v) epoxy resin of phenol-dicyclopentadiene adducts, (vi) aromatic amine, or (vii) carbodilite.

10. A magnet wire comprising:
a conductor comprising copper; and
at least one insulation layer formed around the conductor, the insulation layer comprising:
a matrix thermoplastic polymeric material comprising a polymer including at least one ketone group in one of repeat units in one macromolecule; and
one or more additives incorporated into the matrix polymeric material, wherein the one or more additives mitigate copper poisoning.

11. The magnet wire of claim 10, wherein the matrix polymeric material comprises polyetheretherketone.

12. The magnet wire of claim 10, wherein the one or more additives comprise an acid scavenger, the acid scavenger comprising at least one of (i) a strong base, (ii) a weak base, or (iii) a metal oxide.

13. The magnet wire of claim 12, wherein the one or more additives comprise a strong base, the strong base comprising at least one of (i) lithium hydroxide, (ii) magnesium hydroxide, (iii) calcium hydroxide, (iv) barium hydroxide, or (v) a hydrate of lithium hydroxide, magnesium hydroxide, calcium hydroxide, or barium hydroxide.

14. The magnet wire of claim 12, wherein the one or more additives comprise a weak base, the weak base comprising at least one of (i) aluminum hydroxide, (ii) zirconium (IV) hydroxide, (iii) zirconium (IV) carbonate hydroxide oxide, (iv) aluminum dihydrogen phosphate, (v) sodium hydrogen phosphate, (vi) lead (II) hydroxide acetate, (vii) ammonium bicarbonate, (viii) calcium phosphosilicate, or (ix) molecular sieves.

15. The magnet wire of claim 12, wherein the one or more additives comprise a metal oxide, the metal oxide comprising at least one of (i) vanadium (V) oxide, (ii) barium oxide, (iii) magnesium oxide, (iv) calcium oxide, (v) zirconia, or (vi) titania.

16. The magnet wire of claim 10, wherein the one or more additives comprise a thermal stabilizer, the thermal stabilizer comprising at least one of (i) triaryl phosphate, (ii) aromatic phosphite, (iii) a secondary aromatic amine, (iv) a free-radical scavenger, (v) iron (II) oxalate hydrate, (vi) ferrocene, or (vii) a derivative of ferrocene.

17. The magnet wire of claim 10, wherein the one or more additives comprise a chemical crosslinker, the chemical crosslinker comprising at least one of (i) polyamideimide, (ii) aromatic bismaleimide, (iii) aromatic benzoxazine, (iv) epoxy novalac resin, (v) epoxy resin of phenol-dicyclopentadiene adducts, (vi) aromatic amine, or (vii) carbodilite.

18. A magnet wire comprising:
a conductor comprising copper; and
at least one insulation layer formed around the conductor, the insulation layer comprising:
a matrix thermoplastic polymeric material comprising a polymer including at least one ketone group in one of repeat units in one macromolecule; and
one or more additives incorporated into the matrix polymeric material, wherein the one or more additives mitigate copper poisoning, and
wherein the one or more additives comprise at least one of (i) a strong base, (ii) a weak base), (iii) a thermal stabilizer, (iv) or a chemical crosslinker.

19. The magnet wire of claim 18, wherein the one or more additives comprise at least one of (i) lithium hydroxide, (ii) magnesium hydroxide, (iii) calcium hydroxide, (iv) barium hydroxide, (v) a hydrate of lithium hydroxide, magnesium hydroxide, calcium hydroxide, or barium hydroxide, (vi) aluminum hydroxide, (vii) zirconium (IV) hydroxide, (viii) zirconium (IV) carbonate hydroxide oxide, (ix) aluminum dihydrogen phosphate, (x) sodium hydrogen phosphate, (xi) lead (II) hydroxide acetate, (xii) ammonium bicarbonate, (xiii) calcium phosphosilicate, (xiv) molecular sieves, (xv) vanadium (V) oxide, (xvi) barium oxide, (xvii) magnesium oxide, or (xviii) calcium oxide.

20. The magnet wire of claim 18, wherein the one or more additives comprise at least one of (i) triaryl phosphate, (ii) aromatic phosphite, (iii) a secondary aromatic amine, (iv) a free-radical scavenger, (v) iron (II) oxalate hydrate, (vi) ferrocene, (vii) a derivative of ferrocene, (viii) polyamideimide, (ix) aromatic bismaleimide, (x) aromatic benzoxazine, (xi) epoxy novalac resin, (xii) epoxy resin of phenol-dicyclopentadiene adducts, (xiii) aromatic amine, or (xiv) carbodilite.
